(19) United States
(12) Patent Application Publication
(10) Pub. No.: US 2022/0391765 A1
(43) Pub. Date: Dec. 8, 2022

(54) Systems and Methods for Semi-Supervised Active Learning

(71) Applicant: Terramera, Inc., Vancouver (CA)

(72) Inventors: Oliver SNOW, Squamish (CA); Martin ESTER, Burnaby (CA)

(21) Appl. No.: 17/827,363

(22) Filed: May 27, 2022

Related U.S. Application Data
(60) Provisional application No. 63/194,031, filed on May 27, 2021.

(51) Int. Cl. G06N 20/00

(52) U.S. Cl. CPC G06N 20/00

(57) ABSTRACT

Systems and methods for training machine learning models over labeled and unlabeled datasets are provided. Labels are assigned to unlabeled data by selecting a labeling approach, such as active learning or semi-supervised learning, based on uncertainty in the model's predictions. The selection of the labeling approach may be varied over the course of training, e.g. so that unlabeled dataset samples with progressively more uncertain predictions are pseudo-labeled via semi-supervised learning rather than with active learning, thereby reducing the load on the oracle and recognizing the increasing confidence in the model's overall calibration as training progresses.

### CROSS-REFERENCE TO RELATED APPLICATIONS

This application claims the benefit of U.S. provisional patent application Ser. No. 63/194,031 filed 27 May 2021, the entirety of which is incorporated by reference herein for all purposes.

### TECHNICAL FIELD

The present disclosure relates generally to systems and methods for machine learning, and particularly to systems and methods for active learning and semi-supervised learning.

### BACKGROUND

Active learning is a class of training approach for machine learning models which can reduce the number of labeled examples needed to train a machine learning model. Active learning can involve selecting certain examples and querying an oracle for ground-truth labels of those examples, for instance where the machine learning model is a classifier which predicts labels associated with some measure of certainty (or uncertainty). Queries to the oracle can be made based on uncertainty of predictions for unlabeled examples, such as to select those examples which are close to a decision boundary, e.g. as described by Cohn et al., Active learning with statistical models, Journal of artificial intelligence research, 4:129-145, 1996, arXiv:cs/9603104. Querying based on uncertainty alone can lead to sub-optimal behaviour, however, such as where only data points close to a decision boundary or unrepresentative outliers are selected. Subsequent developments on the topic of active learning have provided more complex queries of unlabeled data, such as querying for examples that are both uncertain and representative of the rest of the data.

Semi-supervised learning is a class of training approach for machine learning models which can involve training a machine learning model based on training data which is initially unlabeled but for which labels have been programmatically generated (e.g. by a machine learning model). Such programmatic generation is sometimes called “pseudo-labeling” and the resulting labels are sometimes called “pseudo-labels”. Training data may be selected for pseudo-labeling based on uncertainty of predictions for unlabeled examples, generally by selecting training data for which high-certainty pseudo-labels are available. Semi-supervised learning may be combined with active learning, e.g. as described by Hakkani-Tur et al. in U.S. Pat. No. 8,010,357.

There is a general desire for improved techniques for training machine learning models, and in particular machine learning techniques with improved efficiency, accuracy, and/or other characteristics. Techniques suitable for specific applications are also desired.

The foregoing examples of the related art and limitations related thereto are intended to be illustrative and not exclusive. Other limitations of the related art will become apparent to those of skill in the art upon a reading of the specification and a study of the drawings.

### SUMMARY

The following embodiments and aspects thereof are described and illustrated in conjunction with systems, tools and methods which are meant to be exemplary and illustrative, not limiting in scope. In various embodiments, one or more of the above-described problems have been reduced or eliminated, while other embodiments are directed to other improvements.

One aspect of the invention provides systems and methods for training a machine learning model. The systems comprise one or more processors and a memory storing instructions which cause the one or more processors to perform operations comprising the methods. The methods comprise: selecting a first sample from an unlabeled training dataset; generating a first label for the first sample by: generating, by the machine learning model, a first prediction based on the first sample and one or more parameters of the machine learning model, the first prediction associated with a confidence measure; comparing the confidence measure to one or more thresholds to yield a labeling determination; selecting and performing at least one of a plurality of labeling techniques based on the labeling determination to yield the first label; training the one or more parameters of the machine learning model over a labeled training dataset, the labeled training dataset comprising the sample and the label; modifying at least one of the one or more thresholds to yield a modified threshold; and generating a second label for a second sample based on the modified threshold.

In some embodiments, the plurality of labeling techniques comprise semi-supervised learning and active learning.

In some embodiments: comparing the confidence measure to one or more thresholds comprises determining whether the confidence measure is greater than a semi-supervised learning threshold; and selecting and performing at least one of a plurality of labeling techniques comprises, in response to determining that the confidence measure is greater than a semi-supervised learning threshold, assigning a pseudo-label to the first sample based on the prediction.

In some embodiments, selecting and performing at least one of a plurality of labeling techniques comprises, in response to determining that the confidence measure is less than or equal to the semi-supervised learning threshold, querying an oracle for a ground-truth label for the first sample.

In some embodiments, comparing the confidence measure to one or more thresholds comprises determining whether the confidence measure is less than an active learning threshold, the active learning threshold less than the semi-supervised learning threshold; and selecting and performing at least one of a plurality of labeling techniques comprises, in response to determining that the confidence measure is less than an active learning threshold, assigning a pseudo-label to the first sample based on the prediction. In some embodiments, assigning the pseudo-label comprises generating the pseudo-label for the first sample based on the prediction.

In some embodiments, the confidence measure comprises a measure of uncertainty in the first prediction; determining whether the confidence measure is greater than a semi-supervised learning threshold comprises determining whether the measure of uncertainty is less than the semi-supervised learning threshold.

In some embodiments, selecting the first sample comprises random sampling.

In some embodiments, modifying the at least one of the one or more thresholds comprises modifying the at least one of the one or more thresholds based on a model uncertainty measure associated with the machine learning model.

In some embodiments, the model uncertainty measure comprises a measure of expected calibration error in the machine learning model. In some embodiments, the model uncertainty measure is based on a number of times the one or more parameters of the machine learning model have been trained. In some embodiments, the model uncertainty measure comprises an average of a plurality of confidence measures associated with a plurality of predictions generated by the machine learning model. In some embodiments, the model uncertainty measure comprises a measure of accuracy of predictions by the machine learning model over a test training dataset, the test training dataset disjoint from the labeled training dataset.

In some embodiments, the method comprises modifying at least one of the one or more thresholds a plurality of times to generate a plurality of modified thresholds; generating, for each of the modified thresholds, one or more labels for one or more samples from the unlabeled dataset; and training the one or more parameters of the machine learning model over at least the one or more labels and one or more samples.

In some embodiments, modifying the at least one of the one or more thresholds a plurality of times comprises iteratively decreasing the uncertainty to which the at least one of the one or more thresholds correspond. In some embodiments, iteratively decreasing the uncertainty comprises increasing a value of the at least one of the one or more thresholds from a starting value in a range of about 0% to 50% of a minimum confidence value to a final value in a range of about 50% to 100% of a maximum confidence value. In some embodiments, the starting value comprises about 20% of the minimum confidence value and the final value comprises about 60% of the maximum confidence value.

In some embodiments, iteratively decreasing the uncertainty comprises determining a value of the at least one of the one or more thresholds based on a sum of a minimum confidence value and the model uncertainty measure.

In some embodiments, the machine learning model comprises an ensemble model, the ensemble model comprising a plurality of sub-models. In some embodiments, the confidence measure comprises a measure of a plurality of predictions generated by the plurality of sub-models based on the first sample.

In some embodiments, the measure of the plurality of predictions comprises at least one of: a variance and a standard deviation based on the plurality of predictions.

In some embodiments, at least one of the plurality of sub-models comprises a neural network. In some embodiments, the machine learning model comprises a Bayesian neural network, the Bayesian neural network operable to generate the first prediction comprising the confidence measure. In some embodiments, the method comprises generating the confidence measure for the first prediction by performing Monte Carlo dropout with the machine learning model based on the first sample.

Aspects of the present disclosure comprise systems and methods for generating predictions by a machine learning model. The systems comprise one or more processors and a memory storing instructions which cause the one or more processors to perform operations comprising the methods. The methods comprise: generating a prediction by the machine learning model based on one or more parameters of the machine learning model, the parameters of the machine learning model having previously been trained according to the methods described above.

Aspects of the present disclosure comprise use of a machine learning model trained according to the methods described above to generate a prediction, and/or use of a system comprising such a machine learning model to generate a prediction.

In addition to the exemplary aspects and embodiments described above, further aspects and embodiments will become apparent by reference to the drawings and by study of the following detailed descriptions.

### BRIEF DESCRIPTION OF THE DRAWINGS

Exemplary embodiments are illustrated in referenced figures of the drawings. It is intended that the embodiments and figures disclosed herein are to be considered illustrative rather than restrictive.

FIG. 1 is a flowchart of an exemplary method for training a machine learning model according to the present disclosure.

FIG. 2 shows schematically an exemplary system for training a machine learning model, for example according to the method of FIG. 1.

FIG. 3 shows an exemplary operating environment that includes at least one computing system for performing methods described herein, such as the method of FIG. 1.

### DESCRIPTION

Throughout the following description specific details are set forth in order to provide a more thorough understanding to persons skilled in the art. However, well known elements may not have been shown or described in detail to avoid unnecessarily obscuring the disclosure. Accordingly, the description and drawings are to be regarded in an illustrative, rather than a restrictive, sense.

Aspects of the present disclosure provide systems and methods for training machine learning models over labeled and unlabeled datasets. Labels are assigned to unlabeled data by selecting a labeling approach, such as active learning or semi-supervised learning, based on uncertainty in the model's predictions. The selection of the labeling approach may be varied over the course of training, e.g. so that unlabeled dataset samples with progressively more uncertain predictions are pseudo-labeled via semi-supervised learning rather than with active learning, thereby reducing the load on the oracle and recognizing the increasing confidence in the model's overall calibration as training progresses.

The terms “uncertainty” and “confidence”, as well as related terms (e.g. “confidence measure”), as used in this disclosure, are used for simplicity and include the converse. For example, a measure of certainty is also considered a measure of uncertainty for the purposes of the present disclosure, and a reference to a “confidence measure” includes measures which provide high values when confidence is high (and low values when confidence is low) and also measures which provide low values when confidence is high (and high values when confidence is low). As another example, where uncertainty is compared between two things, such as where something is said to have “high uncertainty” or “greater uncertainty”, this includes the meaning of having “low certainty” or “less certainty”, respectively (and/or “low confidence” or “less confidence” or the like). Similarly, terms such as “low uncertainty” or “less uncertainty” include the meaning of having “high certainty” or “greater certainty”, respectively (and/or “high confidence” or “greater confidence” or the like). To aid readability, and to avoid repetitively reminding the reader that (e.g.) measures of certainty, lack of confidence, or the like may alternatively or additionally be used, the present disclosure and appended claims generally use “uncertainty”, “confidence”, and related terms without loss of generality, except where the context requires otherwise.

Where measures of uncertainty or confidence are described as being compared to a threshold corresponding to a value expressed in terms of uncertainty or confidence, such disclosure includes (1) the converse comparison being made with the converse measure against the same threshold, (2) the converse comparison being made with the same measure against an equivalent threshold expressed in converse terms, and (3) the same comparison being made with the converse measure against an equivalent threshold expressed in converse terms, except where the context requires otherwise. For instance, disclosure of an uncertainty measure being determined to be less than a threshold, where the threshold corresponds to some value expressed in terms of uncertainty, also includes the following meanings: (1) determining that a certainty measure is greater than the same threshold, (2) determining that a certainty measure is less than a threshold corresponding to an equivalent value expressed in terms of certainty, and (3) determining that an uncertainty measure is greater than a threshold corresponding to an equivalent value expressed in terms of certainty. (For instance, if a measure of uncertainty ranges from 0 to 1, with 1 representing high uncertainty, a threshold of 0.6 expressed in terms of uncertainty may correspond to an equivalent threshold of 0.4 expressed in terms of certainty.)

### A Method for Semi-Supervised Active Learning

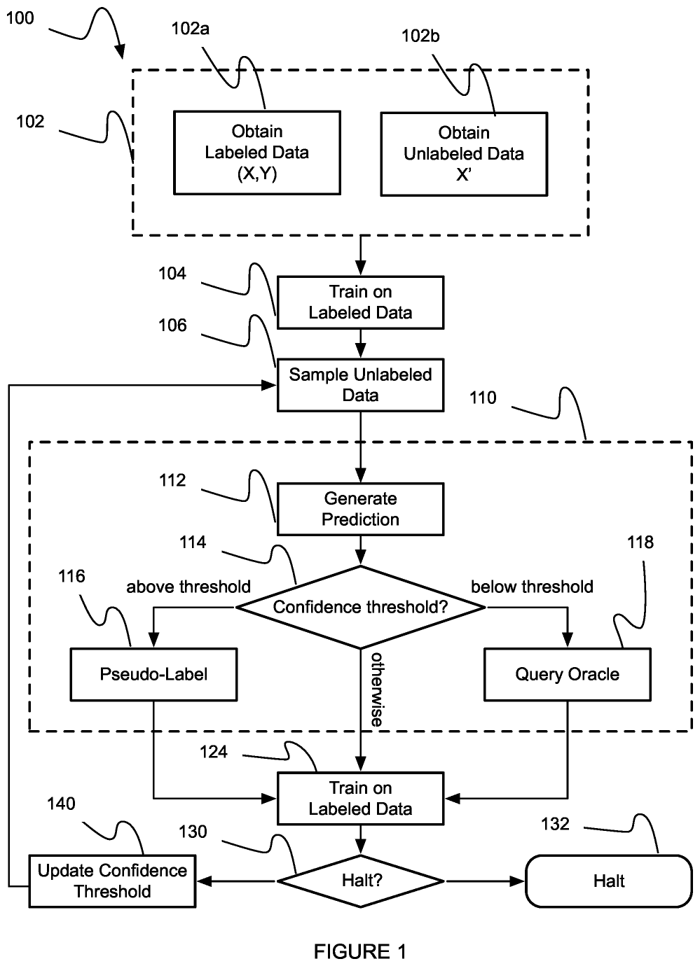

FIG. 1 is a flowchart of an exemplary method 100 for training a machine learning model according to the present disclosure. Method 100 is performed by a processor, such as a processor of computing system 300, described elsewhere herein.

Acts 102 (optionally comprising acts 102a and/or acts 102b) and 104 are optional acts which relate generally to obtaining training data and training a set of initial parameters for the machine learning mode. In some embodiments, one or more training datasets and/or a set of initial parameters for the machine learning model are predetermined or otherwise made available to the processor. For example, the machine learning model may be pre-trained or randomly initialized, and/or one or more training datasets may already be loaded in memory and ready for use. In such cases, and perhaps in others, one or more of acts 102 and 104 may be omitted and method 100 may begin at acts 104 and/or act 106.

At act 102, the processor obtains labeled and/or unlabeled data for training. At act 102a, the processor obtains a labeled dataset (X, Y) comprising data X and corresponding labels Y. At act 102b, the processor obtains an unlabeled dataset X′. Elements of datasets X and X′ correspond in form to the inputs of the machine learning model, and thus have form similar to each other. For example, in an embodiment where the machine learning model receives images with particular dimensions as input, datasets X and X′ comprise images of those dimensions.

At act 104, the processor initializes parameters θ of the machine learning model by training the model over the labeled dataset (X, Y). The machine learning model may be trained in any suitable way. For example, the processor may select one or more batches (D, L)⊆(X, Y) of data D with corresponding labels L and train over the batches to initialize the model's parameters θ, for example by performing inference with the model over D to generate outputs \textcircled{L} and modifying parameters θ to minimize a loss function μ(L, \textcircled{L}), e.g. via backpropagation. The training of act 104 may comprise one or more batches and/or one or more epochs.

At act 106, the processor samples from unlabeled dataset X′ to obtain a sample x′. The processor may, optionally, sample a plurality of samples from unlabeled dataset X′. Any suitable sampling technique may be used. In some embodiments, the processor samples from unlabeled dataset X′ based on a measure of uncertainty associated with elements in unlabeled dataset X′, for example by generating predictions by machine learning model X′ and selecting elements having high uncertainty as samples. In some embodiments, the processor samples from unlabeled dataset X′ based on a measure of representativeness, for example by clustering elements of unlabeled dataset X′ (e.g. via K-means clustering) and sampling from each cluster based on uncertainty.

In some preferred embodiments, the processor randomly samples from unlabeled dataset X′. In certain contexts, such as in at least some chemical discovery embodiments described elsewhere herein, random sampling has a surprising ability to identify diverse and dense samples with relatively much lower computational loads than the uncertainty- and/or representativeness-based sampling approaches mentioned above. Moreover, the potential to randomly select samples with low uncertainty—which can be undesirable when training with active learning—is not necessarily as problematic in the context of semi-supervised active learning as described in greater detail elsewhere herein.

At act 110, the processor generates a label [symbol] for sample x′ based on a prediction y′ generated for sample x′ generated by the machine learning model. The processor may, optionally, generate labels for each a plurality of samples sampled at act 106 (e.g. by performing act 110 a plurality of times, which may be in parallel, in sequence, and/or otherwise ordered). Prediction y′ is associated with a confidence measure c, such as an uncertainty measure, a variance, a standard deviation, and/or any other suitable measure of confidence in prediction y′. The processor generates label [symbol] according to a labeling technique which the processor selects based on confidence measure c according to a selection criterion. The labeling techniques may include, for example, semi-supervised learning, active learning, and/or any other suitable labeling technique. The selection criterion may comprise, for example, comparing confidence measure c to one or more thresholds {tₙ}. For instance, the processor may select active learning if confidence measure c indicates low confidence (e.g. if confidence measure c indicates lower confidence than a threshold t₁) and semi-supervised learning if the confidence measure indicates high confidence (e.g. if confidence measure c indicates higher confidence than threshold t₁ and/or a different, more-confident threshold t₂).

As discussed in greater detail below (e.g. with respect to act 140), the selection criterion is updated over the course of performing method 100 such that the processor may select different labeling techniques for a given confidence measure c at different times. For example, the processor might select active learning for a given prediction y′ with confidence measure c if generated early in training, whereas the processor might select semi-supervised learning for the same prediction y′ with the same confidence measure c if generated later in training, e.g. due to a threshold being modified in the interim causing the processor to select semi-supervised learning for confidence measures indicating lower confidence. This example is provided to illustrate changes in the performance of the method over the course of training, and not to suggest that the processor must generate multiple predictions y′ for a given sample x′ at various times during training. In at least some embodiments, the processor generates a prediction y′ at most once for each sample x′ over the course of method 100. For instance, the processor may remove the sample x′ from unlabeled dataset X′ after generating a prediction y′ and/or a label [symbol] for sample x′ to prevent re-labeling.

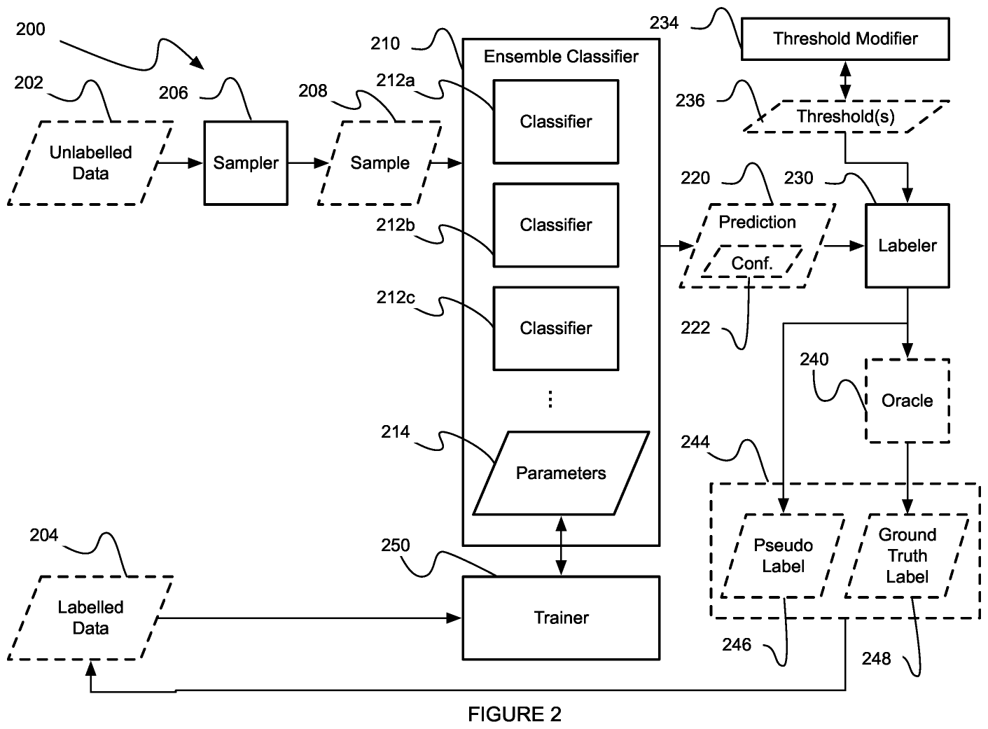

In at least the depicted embodiment of FIG. 1, act 110 comprises several acts. At act 112, the processor generates a prediction p for sample x′ by performing inference over sample x′ with the machine learning model based on the machine learning model's current parameters θ. Also at act 112, the processor associates prediction p with a confidence measure c. As noted elsewhere herein, confidence measure c may comprise a measure of confidence, certainty, uncertainty, lack of confidence, and/or any other suitable measure relating to confidence in prediction p. Confidence measure c may be associated with prediction p in any suitable way. In some embodiments, confidence measure c is a component of prediction p. For example, the machine learning model may comprise a classifier operable to generate a prediction p comprising a distribution over labels, and the probability associated with a label in prediction p (e.g. the modal label) can be used as a confidence measure. As another example, the machine learning model may be explicitly probabilistic, such as in the case of a Bayesian neural network, and may natively generate confidence measure c. In some embodiments, the machine learning model comprises an ensemble model having a plurality of sub-models (e.g. as depicted in FIG. 2) and confidence measure c for prediction p may be determined based on the distribution of results produced by the sub-models, e.g. by determining an average confidence, variance in predictions, standard deviation in predictions, and/or any other suitable measure. In some embodiments, the processor generates a plurality of predictions based on the machine learning model by modifying the machine learning model for each prediction, e.g. by performing Monte Carlo dropout, and generate confidence measure c based on the plurality of predictions (e.g. by determining an average confidence, variance in predictions, standard deviation in predictions, and/or any other suitable measure). Further exemplary techniques for determining confidence in machine learning models' predictions are disclosed by, for example, Lakshminarayanan et al., Simple and scalable predictive uncertainty estimation using deep ensembles, arXiv:1612.01474 (2016) and Ovadia et al., Can you trust your model's uncertainty? evaluating predictive uncertainty under dataset shift, arXiv:1906.02530 (2019), incorporated herein by reference for all purposes.

At act 114, the processor compares confidence measure c to one or more thresholds {tₙ} to yield a labeling determination. Based on the labeling determination, the processor proceeds on to perform semi-supervised learning at act 116 or active learning at act 118. In some embodiments, the comparison at act 114 comprises determining whether confidence measure c is more confident than a threshold t; if so (e.g. if c>t, assuming c and t are expressed in terms of confidence; this assumption is also made for convenience in other examples in this paragraph), the processor proceeds on to act 116 and, if not (e.g. if c<t), the processor proceeds on to act 118. (If c=t the processor may proceed to either act 116 or act 118, depending on implementation.) In some embodiments, the comparison comprises determining whether confidence measure c indicates greater confidence than a semi-supervised learning threshold t₁ (e.g. c>t₁) and, if so, proceeding on to act 116; determining whether confidence measure c indicates less confidence than an active learning threshold t₂ (e.g. c<t₂) and, if so, proceeding on to act 118. If the processor does not proceed to either of acts 116 or 118 (e.g. if t₁<c<t₂) then the processor may apply another suitable labeling technique and/or may skip labeling sample x′ at least for this iteration of act 110 (shown as proceeding to act 124 in FIG. 1). As noted elsewhere herein, the example inequalities mentioned here (e.g. c>t) are reversed if the terms are expressed in terms of uncertainty (so, e.g., the first-mentioned inequality would read c<t).

Act 116 corresponds to a semi-supervised learning approach to labeling sample x′. At act 116, the processor assigns a pseudo-label to sample x′ based on prediction y′. Label [symbol] comprises the pseudo-label assigned at act 116. Any suitable pseudo-labeling technique may be used. Prediction p may comprise label [symbol] , and/or may be transformable into label [symbol] via a suitable transformation routine. For example, where the machine learning model comprises a classifier operable to generate a label from an input, the machine learning model may generate label [symbol] from sample x′, e.g. by determining [symbol] =y′. As another example, where the machine learning model comprises a classifier operable to generate a distribution over labels from an input, the machine learning model may generate a distribution from sample x′ and the distribution may be transformed by, e.g., determining the mode of the distribution to yield label [symbol] , e.g. by determining [symbol] =mode(y′). As a further example, where the machine learning model generates a prediction of some other form, a classifier ψ may be applied to prediction y′ to generate a label [symbol] , e.g. by determining [symbol] =ψ(y′). In at least some embodiments, sample x′ and the corresponding pseudo-label (together, (x′, [symbol] )) are added to labeled dataset (X, Y). In some embodiments, sample x′ is retained in unlabeled dataset X′ to allow for improved pseudo-labels to be generated for sample x′ later in training. A pseudo-labeled sample (x′, [symbol] ) added to labeled dataset (X, Y) may optionally replace a previously-added pseudo-labeled sample. In some embodiments, sample x′ is removed from unlabeled dataset X′ after labeling at act 116 to prevent re-labeling.

Act 118 corresponds to an active learning approach to labeling sample x′. At act 118, the processor queries an oracle acquire a ground-truth label for sample x′. Label [symbol] comprises the ground-truth label acquired at act 118. Any suitable query and oracle may be used. For example, the oracle may comprise a human domain expert, a computing system, one or more sensors, a laboratory, and/or any other source of high-accuracy labels for unlabeled dataset X′. The query may comprise, for example, generating a request for a ground-truth label for sample x′, and/or generating a list of samples (including sample x′) which a user and/or another system may present to the oracle. Act 118 may further comprise receiving label [symbol] for sample x′ from the oracle (optionally via one or more intermediaries, which may comprise users, systems, etc.). Receipt of label [symbol] may occur a significant period of time after querying the oracle, particularly in embodiments where the oracle performs laboratory tests, field surveys, and/or other laborious activities to produce label [symbol] . In some embodiments, some queries may not be answerable by the oracle. In some embodiments, sample x′ and the corresponding ground-truth label (together, (x′, [symbol] )) are added to a batch (D, L) for subsequent training and/or to labeled dataset (X, Y). Addition to labeled dataset (X, Y) may be accompanied by removal of sample x′ from unlabeled dataset X′, thereby avoiding potentially-costly additional queries to the oracle for sample x′.

At act 124, the processor trains parameters 0 of the machine learning model by training the model over the labeled dataset (X, Y), which now includes one or more samples x′ and labels [symbol] (together, (x′, [symbol] )) labeled as described above with reference to act 110. The machine learning model may be trained in any suitable way, e.g. as described with reference to act 104. Act 124 may comprise training parameters θ of the machine learning model over one or more epochs, each of which may comprise one or more batches. In some embodiments, the training of act 124 comprises one epoch over the labeled dataset (X, Y), thereby allowing for additional newly-labeled samples (x′, [symbol] ) to be potentially included with each epoch.

At act 130, the processor determines whether to halt training of the machine learning model. This determination may be performed in any suitable way, for example by halting after a predetermined number of iterations of act 124, after a target accuracy of the machine learning model over a validation set is achieved, after a predetermined number of queries to the oracle are performed, and/or after any other suitable halting criterion is met. If the processor determines that training is to be halted at act 130, method 100 halts at act 132. Otherwise, the processor continues to act 140. Act 130 may optionally or alternatively be performed at other times, such as after act 140, after act 106, and/or at any other suitable time.

At act 140, the processor modifies the selection criterion used at act 110 to select labeling techniques. In some embodiments, the processor modifies at least one of the one or more thresholds {tₙ} to yield a modified threshold t*. In some embodiments, the processor modifies the selection criterion, such as thresholds {tₙ}, based on a model uncertainty measure associated with the machine learning model. The model uncertainty measure may comprise an expected calibration error for the machine learning model, a number of times the parameters θ of the machine learning model have been trained (e.g. the number of iterations of act 124, the number of epochs of training, etc.), an average of a plurality of confidence measures associated with a plurality of predictions generated by the machine learning model, a measure of accuracy of predictions by the machine learning model over a test dataset comprising labeled data separate from the labeled dataset (i.e. data over which the machine learning model is not trained at act 124), and/or any other suitable measure of model uncertainty. As noted above, the model uncertainty measure may optionally comprise a measure of model certainty.

In suitable circumstances, model uncertainty will tend to decrease as the machine learning model is trained. The model uncertainty measure will also tend to reflect decreased model uncertainty (which may numerically involve increasing if expressed in terms of certainty or decreasing if expressed in terms of uncertainty), although the model uncertainty measure is not required to be an exact measure of model uncertainty. As the model uncertainty measure changes to reflect reduced model uncertainty, the processor will pseudo-label samples x′ with lower-confidence predictions y′ than would have previously (prior to the modifying of act 140) qualified for pseudo-labeling and/or will decline to query the oracle predictions y′ with confidence measures which would previously have qualified for querying. For example, in an embodiment where thresholds {tₙ} are expressed in terms of uncertainty such that larger values are less certain, act 140 may comprise decreasing the values of one or more such thresholds (e.g. threshold t, semi-supervised threshold t₁ and/or active learning threshold t₂, mentioned above with respect to act 114). In an embodiment where thresholds {tₙ} are expressed in terms of certainty such that larger values are more certain, act 140 may comprise increasing the values of one or more such thresholds. Act 140 may be performed a plurality of times over the course of performing method 100, thereby iteratively increasing or decreasing (as appropriate) one or more thresholds {tₙ}. In some embodiments, the processor may increase (or decrease) thresholds on certain iterations of act 140 but not others (e.g. by modifying thresholds every n^{th} iteration).

In some embodiments, the model uncertainty measure comprises a measure of expected calibration error. Expected calibration error may be denoted ECE and may be calculated based on:

$$ECE = {\sum }_{m = 1}^{M} \frac{\vert {B}_{m} \vert}{n} \vert acc ( {B}_{m} ) - conf ( {B}_{m} ) \vert$$

where n is the number of samples, Bᵢ is the i^{th} bin of samples (drawn from labeled dataset X and/or a labeled validation dataset), acc(Bᵢ) is a measure of model prediction accuracy over samples of bin Bᵢ (e.g. mean square error of model predictions over samples of bin Bᵢ), conf(Bᵢ) is a measure of model confidence in samples of bin Bᵢ (e.g. an average of confidence measures c for samples of bin Bᵢ), and M is a number of bins over which to calculate expected calibration error. M may be predetermined, provided by a user, and/or otherwise suitably provided. Numerically, ECE calculated as shown above will tend to decrease as model uncertainty decreases, although the present disclosure includes formulations where ECE increases as model uncertainty increases (e.g. formulations such as—ECE and/or 1—ECE).

In some embodiments, the processor initializes a value of at least one threshold, such as threshold t mentioned above, to a starting value equivalent to a confidence measure in a range of about 0% to 50% of a minimum confidence value. Such initializing may occur at any suitable time prior to or during the first iteration of act 114. The processor may modify (e.g. via one modification and/or a plurality of iterative modifications) the at least one threshold to a final value equivalent to a confidence measure in a range of about 50% to 100% of a maximum confidence value (thus reflecting lower uncertainty than the starting value) at act 140. For instance, in an embodiment where confidence measures are expressed as a value in the range [0,1] with 1 being higher-confidence than 0, the minimum confidence value is 0, the maximum confidence value is 1, the starting value is in the range [0,0.5], and the final value is in the range [0.5,1].

For instance, in at least one example embodiment, the starting value comprises about 20% of the minimum confidence value (e.g. 0.2) and the final value comprises about 60% of the maximum confidence value (e.g. 0.6). The processor may modify the threshold (e.g. threshold t) by adding to the starting value the product of the uncertainty measure (e.g. expected calibration error) with the size of the range between the starting and final values. For instance, the processor may update the value of threshold t to correspond to a confidence measure based on:

$$c = s + E \times \frac{f - s}{f}$$

where c is the confidence measure to which t corresponds, s is the starting value, f is the final value, and E is the uncertainty measure (e.g. expected calibration error) expressed in the interval [0,1].

In some embodiments, the processor initializes a value of at least one threshold, such as threshold t mentioned above, to a starting value. For the purposes of this example, and without loss of generality as noted above, the value of threshold t is assumed to be in confidence terms, with larger values indicating greater confidence than smaller values. The processor may modify (e.g. via one modification and/or a plurality of iterative modifications) the at least one threshold over the course of training by adding to the starting value a value of the model uncertainty measure, which decreases over the course of training. For example, the model uncertainty measure may comprise an expected calibration error, e.g. expressed as a value in the range [0,1] with 0 indicating low uncertainty (high confidence) and 1 indicating high uncertainty (low confidence). For instance, the starting value may be 0.1, 0.2, 0.3, 0.4, 0.5, 0.6, 0.7, 0.8, or 0.9. The processor may add to the starting value the expected calibration error, such that an expected calibration error of 0.5 and a starting value of 0.2 would correspond to a threshold of 0.7 and decreasing the expected calibration error to 0.3 would cause the processor to change the threshold to 0.5. In some embodiments out-of-range values (e.g. values greater than 1 in this example) may be mapped by the processor to an in-range value (e.g. by mapping values greater than 1 to 1) and/or avoided by normalizing the uncertainty measure to the size of a permitted range of values (e.g. from a minimum of 0 to a maximum of 1−s, where s is the starting value).

In at least some embodiments, the processor proceeds from act 140 to act 106 to sample a further sample x′ as described above. The processor proceeds from act 106 to act 110, where the processor generates a further label [symbol] for the further sample x′ based on the modified labeling criterion (e.g. modified threshold t*). For example, if the machine learning model generates a prediction y′ for sample x′ with confidence measure c=0.4 and in the previous iteration of act 140 the threshold t applied at act 114 was reduced from 0.41 to 0.39 then at act 110 the processor will pseudo-label sample x′ (via act 116) rather than query the oracle (via act 118), whereas on the preceding iteration of act 110 the processor would have queried the oracle in response to the same sample x′ and prediction y′. This dynamic response to model uncertainty reflects increasing confidence in the machine learning model's predictions over the course of training and, in suitable circumstances, can reduce the number of queries to the oracle and/or provide improved performance and/or accuracy with a given number of queries to the oracle.

An example embodiment of method 100 is described as follows:

Data: (X, Y) labeled data, X′ Unlabeled data
Result: Weights: [symbol]
let (Xᵥ, Yᵥ) ⊂ (X, Y), initialize weights of NN [symbol] ;
train model [symbol] on (X, Y) minimizing loss function L;
while condition not satisfied do

| \| | randomly sample batch Bₙ of examples in X′; | | |
|---|---|---|---|
| \| | foreach x′ ∈ Bₙ do | | |
| \| | \| | infer y′ and confidence p using [symbol] , [symbol] and x′; | |
| \| | \| | calculate ECE of [symbol] on (Xᵥ, Yᵥ); | |
| \| | \| | t = minconf + ECE; | |
| \| | \| | if p above confidence threshold t then | |
| \| | \| | \| | pseudo-label using y′; |
| \| | \| | \| | (X, Y) ← (X, Y) ∪ {(x′, y′)}; |
| \| | \| | else | |
| \| | \| | \| | p below confidence threshold t; |
| \| | \| | \| | ask oracle for ground truth, g′; |
| \| | \| | \| | (X, Y) ← (X, Y) ∪ {(x′, g′)}; |

| | | |
|---|---|---|
| \| | \| | end |

| | |
|---|---|
| \| | end |
| \| | train [symbol] for e epochs on (X, Y), minimizing L; |

end
repeat until satisfied

In this example, terms such as X, Y, X′, x′, y′, and other previously-introduced terms have the same meanings as previously presented. In this example, the machine learning model [symbol] comprises a neural network having parameters referred to as weights [symbol] , the weights [symbol] of machine learning model [symbol] are trained based on a loss function L, minconf is a value indicating a minimum confidence value for a threshold t (and is an example of a starting value s for a threshold t, e.g. as described above), p is a confidence measure for prediction y′ (and is an example of a confidence measure c, e.g. as described above), and condition is a halting criterion.

### A System for Semi-Supervised Active Learning

FIG. 2 shows schematically an exemplary system 200 for training a machine learning model, for example according to the method of FIG. 1. System 200 comprises a computing system as described in greater detail elsewhere herein. System 200 may interact with various inputs and outputs (shown in dashed lines), which are not necessarily part of system 200, although in some embodiments some or all of these inputs and outputs are part of system 200 (e.g. in an example embodiment, thresholds 236 are part of system 100).

System 200 comprises a machine learning model 210. Machine learning model 210 has parameters 214, on the basis of which machine learning model 210 transforms inputs (e.g. sample 208) into outputs (e.g. prediction 220). In at least the depicted embodiment machine learning model 210 comprises an ensemble classifier comprising a plurality of sub-models 212a, 212b, 212c, . . . (collectively and individually “sub-models 212”). For example, machine learning model 210 may comprise an ensemble of neural networks (e.g. deep neural networks), such as is described by Lakshminarayanan et al., Simple and scalable predictive uncertainty estimation using deep ensembles, arXiv:1612.01474 (2016).

System 200 trains machine learning model 210 over unlabeled data 202 and labeled data 204, e.g. according to method 100. In some embodiments, trainer 250 initializes parameters 214 by training the machine learning model 210 over labeled data 204, e.g. as described with respect to act 104 of method 100.

System 200 comprises a sampler 206. Sampler 206 samples one or more samples 208 from unlabeled data 202, e.g. as described with respect to act 106 of method 100. System 200 causes machine learning model 210 to generate a prediction 220 for each sample 208, e.g. as described with respect to act 112 of method 100. In some embodiments prediction 220 comprises a confidence measure 222 (e.g. as shown in the depicted embodiment); in some embodiments the processor associates prediction p with a confidence measure c via a suitable transformation, e.g. as described with respect to act 112 of method 100.

System 200 comprises a labeler 230. Labeler 230 generates a label 244 for each sample 208 based on a labeling technique which is selected based on confidence measure 222 according to a selection criterion, e.g. as described with reference to act 114 of method 100. In at least the depicted embodiment, the selection criterion comprises one or more thresholds 236. For example, labeler 230 may determine that confidence measure 222 corresponds to a greater level of confidence than is indicated by a threshold 236 and, on that basis, may assign a pseudo-label 246 to sample 208, e.g. as described with reference to act 116 of method 100. As another example, labeler 230 may determine that confidence measure 222 for a sample 208 corresponds to a lesser level of confidence than is indicated by a threshold 236 and, on that basis, may query an oracle 240 for a ground-truth label 248, e.g. as described with respect to act 118 of method 100.

System 200 comprises trainer 250. System 200 may add one or more samples 208 with corresponding labels 244 to labeled data 204 and, via trainer 250, further train parameters 214 of model 210, e.g. as described with reference to act 124 of method 100. System 200 may proceed to iteratively sample further samples 208 via sampler 206, generate further labels 244 via labeler 230, and train parameters 214 over such further samples 208 and labels 244 via trainer 250, e.g. as described elsewhere herein.

System 200 comprises a threshold modifier 234. Threshold modifier 234 modifies thresholds 236, e.g. as described with reference to act 140 of method 100. As a model uncertainty measure associated with machine learning model 210 changes to reflect reduced model uncertainty over the course of training, threshold modifier 234 may modify thresholds 236 to allow pseudo-labeling at lower levels of confidence and to limit the querying of oracle 240 to samples 208 for which predictions 220 have confidence measures 222 with progressively lower levels of confidence. Threshold modifier 234 may modify thresholds 236 at any suitable time, including but not limited to after completing an epoch of training via trainer 250. In some embodiments, threshold modifier 234 may monitor a model uncertainty measure on an ongoing basis (e.g. based on a rolling average of uncertainty in predictions 220, based on average uncertainty of predictions generated for during each batch of training by trainer 250, etc.) and may modify thresholds based on the model uncertainty measure at any suitable time, including mid-epoch.

### Generating Predictions with Machine Learning Models Trained with Semi-Supervised Active Learning

A machine learning model (e.g. machine learning model 210 and/or a sub-model 212) may be used to generate predictions based on parameters trained in accordance with the systems and method disclosed herein. For example, in response to receiving an input, a processor may cause the input to be transformed based on the machine learning model's trained parameters to produce a prediction as output. Specific examples of applications where the presently-disclosed systems and methods are thought to potentially provide advantages in the training and/or performance (e.g. in inference) of a machine learning model are described below.

### Application: Chemical Synergy

The present disclosure can potentially be advantageous in certain applications where labeled training data is scarce relative to unlabeled data, unlabeled data is abundant, and/or the cost of labeling data (e.g. in terms of time, expertise, resources, etc.) is high. Such applications can include, for example, the discovery of synergistic chemical structures. In some embodiments, the machine learning model receives as input representations of a first chemical structure and a second chemical structure and produces as output a prediction of synergy between the two.

For example, in at least one embodiment the machine learning model comprises a model for predicting synergistic pesticidal compositions, e.g. as described in PCT application no. PCT/CA2020/051285 and U.S. patent application Ser. No. 62/987,751, incorporated herein by reference. The machine learning model may be trained over labeled training data comprising indications of synergistic pesticidal efficacy between sets of two or more molecules for a given pest, and the machine learning model may generate predictions of synergistic pesticidal efficacy on a pest. It is highly laborious to obtain laboratory or field data on pesticidal efficacy, which each test taking weeks or months to complete, but raw chemical data is abundant in sources such as PubChem. In some embodiments, such a machine learning model is trained over a set of labeled data as described above and over a comparatively-larger set of unlabeled data comprising chemical molecule structures (e.g. in pairs and/or higher-order tuples, and/or represented individually and combined into pairs and/or higher-order tuples in the course of training) in accordance with the systems and methods described herein.

In some embodiments, the number of queries to the oracle (e.g. between one epoch and the next, and/or over the course of training) are constrained. For example, the selection criterion for selecting labeling techniques may be chosen to reduce the number of queries to the oracle, for example by setting the active learning threshold t₂ (and/or threshold t) to a value corresponding to a confidence no greater than an upper confidence threshold, the upper confidence threshold set sufficiently low as to allow only highly uncertain predictions to qualify for queries to the oracle, such as predictions having confidence c<0.5, c<0.4, c<0.3, c<0.2, or any other suitable value. For example, in some embodiments such a threshold may be set empirically by performing act 112 of method 100 for a plurality of samples (thus generating a plurality of predictions) and setting the active learning threshold t₂ (and/or threshold t) to the confidence measure for the n^{th}-most-uncertain prediction (and/or any other suitable value for a confidence measure), for some predetermined number n. Active learning threshold t₂ (and/or threshold t) may be further reduced from that value over the course of training, e.g. as described elsewhere herein.

Alternatively, or in addition, the samples which qualify for queries to the oracle based on the selection criterion (referred to for convenience as candidate samples) may be generated as described elsewhere herein (e.g. by random sampling) and, if the number m of candidate samples exceeds a predetermined number n of queries which may be made to the oracle, the candidate samples may be reduced to n samples for querying. In some embodiments, n candidate samples are randomly selected for querying from the larger pool of m candidate samples. In some embodiments, the m candidate samples are reduced according to an active learning filter. For example, the m candidate samples may be grouped for representativeness, e.g. via clustering, a density-based approach, and/or any other suitable technique. At most a predetermined number n of candidate samples may be submitted to the oracle, with the selection of such candidate samples based on the groups. Such selection may occur in any suitable way; for example, by forming a predetermined number n of clusters and submitting the most uncertain sample (i.e. the sample with the most uncertain prediction) from each cluster, and/or by forming clusters in any suitable way and submitting selecting one sample from each group up to a predetermined number n (and, optionally if there are fewer than n groups, selecting second samples from one or more clusters before selecting a third sample from any given cluster, and so on).

### Example System Implementation

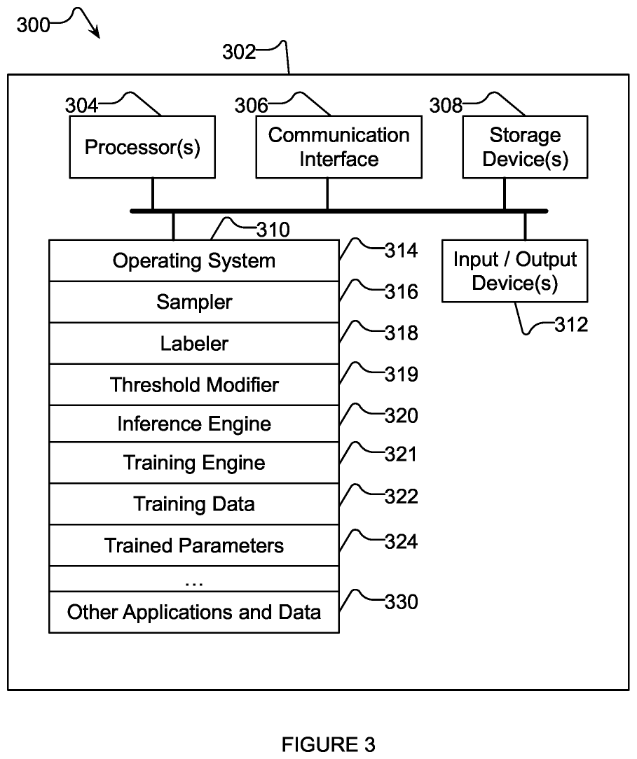

FIG. 3 illustrates a first exemplary operating environment 300 that includes at least one computing system 302 for performing methods described herein. System 302 may be any suitable type of electronic device, such as, without limitation, a mobile device, a personal digital assistant, a mobile computing device, a smart phone, a cellular telephone, a handheld computer, a server, a server array or server farm, a web server, a network server, a blade server, an Internet server, a work station, a mini-computer, a mainframe computer, a supercomputer, a network appliance, a web appliance, a distributed computing system, multiprocessor systems, or combination thereof. System 302 may be configured in a network environment, a distributed environment, a multi-processor environment, and/or a stand-alone computing device having access to remote or local storage devices.

A computing system 302 may include one or more processors 304, a communication interface 306, one or more storage devices 308, one or more input and output devices 312, and a memory 310. A processor 304 may be any commercially available or customized processor and may include dual microprocessors and multi-processor architectures. The communication interface 306 facilitates wired or wireless communications between the computing system 302 and other devices. A storage device 308 may be a computer-readable medium that does not contain propagating signals, such as modulated data signals transmitted through a carrier wave. Examples of a storage device 308 include without limitation RAM, ROM, EEPROM, flash memory or other memory technology, CD-ROM, digital versatile disks (DVD), or other optical storage, magnetic cassettes, magnetic tape, magnetic disk storage. In at least some embodiments such embodiments of storage device 308 do not contain propagating signals, such as modulated data signals transmitted through a carrier wave. There may be multiple storage devices 308 in the computing system 302. The input/output devices 312 may include a keyboard, mouse, pen, voice input device, touch input device, display, speakers, printers, etc., and any combination thereof.

The memory 310 may be any non-transitory computer-readable storage media that may store executable procedures, applications, and data. The computer-readable storage media does not pertain to propagated signals, such as modulated data signals transmitted through a carrier wave. It may be any type of non-transitory memory device (e.g., random access memory, read-only memory, etc.), magnetic storage, volatile storage, non-volatile storage, optical storage, DVD, CD, floppy disk drive, etc. that does not pertain to propagated signals, such as modulated data signals transmitted through a carrier wave. The memory 310 may also include one or more external storage devices or remotely located storage devices that do not pertain to propagated signals, such as modulated data signals transmitted through a carrier wave.

The memory 310 may contain instructions, components, and data. A component is a software program that performs a specific function and is otherwise known as a module, program, engine, and/or application. The memory 310 may include an operating system 314, a sampler 316, a labeler 318, a threshold modifier 319, an inference engine 320, a training engine 321, training data 322 (e.g. comprising labeled and/or unlabeled training data), trained parameters 324 (e.g. comprising parameters 214), and other applications and data 330. Depending on the embodiment, some such elements may be wholly or partially omitted. For example, an embodiment intended for inference and which has trained parameters 324 generated according by the systems and/or methods disclosed herein might omit training engine 321, training data 322, sampler 316, labeler 318, and/or threshold modifier 319. As another example, memory 310 may include no training data 322 prior to starting training (e.g. via method 100 and/or system 200) and may receive training data (in whole or in part) via an input device 312 and/or from a storage device 308.

While a number of exemplary aspects and embodiments have been discussed above, those of skill in the art will recognize certain modifications, permutations, additions and sub-combinations thereof. It is therefore intended that the following appended claims and claims hereafter introduced are interpreted to include all such modifications, permutations, additions and sub-combinations as are within their true spirit and scope.

1. A method for training a machine learning model, the method performed by a processor and comprising:
selecting a first sample from an unlabeled training dataset;
generating a first label for the first sample by:
generating, by the machine learning model, a first prediction based on the first sample and one or more parameters of the machine learning model, the first prediction associated with a confidence measure;
comparing the confidence measure to one or more thresholds to yield a labeling determination;
selecting and performing at least one of a plurality of labeling techniques based on the labeling determination to yield the first label;
training the one or more parameters of the machine learning model over a labeled training dataset, the labeled training dataset comprising the sample and the label;
modifying at least one of the one or more thresholds to yield a modified threshold; and
generating a second label for a second sample based on the modified threshold.

2. The method according to claim 1 wherein the plurality of labeling techniques comprise semi-supervised learning and active learning.

3. The method according to claim 2 wherein:
comparing the confidence measure to one or more thresholds comprises determining whether the confidence measure is greater than a semi-supervised learning threshold; and
selecting and performing at least one of a plurality of labeling techniques comprises, in response to determining that the confidence measure is greater than a semi-supervised learning threshold, assigning a pseudo-label to the first sample based on the prediction.

4. The method according to claim 3 wherein selecting and performing at least one of a plurality of labeling techniques comprises, in response to determining that the confidence measure is less than or equal to the semi-supervised learning threshold, querying an oracle for a ground-truth label for the first sample.

5. The method according to claim 3 wherein:
comparing the confidence measure to one or more thresholds comprises determining whether the confidence measure is less than an active learning threshold, the active learning threshold less than the semi-supervised learning threshold; and
selecting and performing at least one of a plurality of labeling techniques comprises, in response to determining that the confidence measure is less than an active learning threshold, assigning a pseudo-label to the first sample based on the prediction.

6. The method according to claim 3 wherein:
assigning the pseudo-label comprises generating the pseudo-label for the first sample based on the prediction; and/or
wherein the confidence measure comprises a measure of uncertainty in the first prediction; determining whether the confidence measure is greater than a semi-supervised learning threshold comprises determining whether the measure of uncertainty is less than the semi-supervised learning threshold.

7. (canceled)

8. The method according to claim 1 wherein selecting the first sample comprises random sampling.

9. The method according to claim 1 wherein modifying the at least one of the one or more thresholds comprises modifying the at least one of the one or more thresholds based on a model uncertainty measure associated with the machine learning model.

10. The method according to claim 9 wherein:
the model uncertainty measure comprises a measure of expected calibration error in the machine learning model; and/or
wherein the model uncertainty measure is based on a number of times the one or more parameters of the machine learning model have been trained.

11. (canceled)

12. The method according to claim 9 wherein:
the model uncertainty measure comprises an average of a plurality of confidence measures associated with a plurality of predictions generated by the machine learning model and/or
wherein the model uncertainty measure comprises a measure of accuracy of predictions by the machine learning model over a test training dataset, the test training dataset disjoint from the labeled training dataset.

13. (canceled)

14. The method according to claim 9 comprising:
modifying at least one of the one or more thresholds a plurality of times to generate a plurality of modified thresholds;
generating, for each of the modified thresholds, one or more labels for one or more samples from the unlabeled dataset; and
training the one or more parameters of the machine learning model over at least the one or more labels and one or more samples.

15. The method according to claim 14 wherein modifying the at least one of the one or more thresholds a plurality of times comprises iteratively decreasing the uncertainty to which the at least one of the one or more thresholds correspond.

16. The method according to claim 15 wherein iteratively decreasing the uncertainty comprises increasing a value of the at least one of the one or more thresholds from a starting value in a range of about 0% to 50% of a minimum confidence value to a final value in a range of about 50% to 100% of a maximum confidence value; wherein optionally the starting value comprises about 20% of the minimum confidence value and the final value comprises about 60% of the maximum confidence value.

17. (canceled)

18. The method according to claim 15 wherein iteratively decreasing the uncertainty comprises determining a value of the at least one of the one or more thresholds based on a sum of a minimum confidence value and the model uncertainty measure.

19. The method according to claim 1 wherein the machine learning model comprises an ensemble model, the ensemble model comprising a plurality of sub-models.

20. The method according to claim 18 wherein the confidence measure comprises a measure of a plurality of predictions generated by the plurality of sub-models based on the first sample; wherein optionally the measure of the plurality of predictions comprises at least one of: a variance and a standard deviation based on the plurality of predictions.

21. (canceled)

22. The method according to claim 18 wherein at least one of the plurality of sub-models comprises a neural network.

23. The method according to claim 1:
wherein the machine learning model comprises a Bayesian neural network, the Bayesian neural network operable to generate the first prediction comprising the confidence measure; and/or
comprising generating the confidence measure for the first prediction by performing Monte Carlo dropout with the machine learning model based on the first sample.

24. (canceled)

25. The method according to claim 1 wherein the machine learning model is operable to receive a first representation of a first chemical structure and a second representation of a second chemical structure as input and to produce a prediction of synergy between the first and second chemical structures as output.

26. The method according to claim 25 wherein the unlabeled training dataset comprises a plurality of representations of chemical structures and the labeled training dataset comprises a plurality of sets of representations of chemical structures, each set of representations comprising a plurality of representations, the labeled training dataset further comprising, for each set of representations, and indication of synergy between the chemical structures of the set; wherein optionally, for each set of representations of chemical structures, the indication of synergy comprises an indication of synergistic pesticidal efficacy of a chemical composition comprising the chemical structures of the set against a target pest; wherein further optionally the method comprises constraining a number of queries to an oracle for ground-truth labels to less than a predetermined number.

27. (canceled)

28. (canceled)

29. (canceled)

30. (canceled)

31. (canceled)
